(19) United States
(12) Patent Application Publication
(10) Pub. No.: US 2007/0154147 A1
(43) Pub. Date: Jul. 5, 2007

(54) Mechanism to increase an optical link distance

(76) Inventors: Jan P. Peeters Weem, Union City, CA (US); Tom Mader, Los Gatos, CA (US); Peter Kirkpatrick, San Francisco, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/320,935

(22) Filed: Dec. 29, 2005

(51) Int. Cl. G02B 6/36

(52) U.S. Cl. 385/88

(57) ABSTRACT

A system is disclosed. The system includes a multimode optical fiber and a network controller coupled to the optical fiber. The network controller includes a receiver and an electrical dispersion compensation (EDC) unit to compensate for modal dispersion in optical signals received from the optical fiber.

### FIELD OF THE INVENTION

The present invention relates to fiber optic communications; more particularly, the present invention relates to increasing the distance of an optical link.

### BACKGROUND

Currently, optical input/output (I/O) is used in network systems to transmit data between computer system components. Optical I/O is able to attain higher system bandwidth with lower electromagnetic interference than conventional I/O methods. In order to implement optical I/O, radiant energy is coupled to a fiber optic waveguide from an optoelectronic integrated circuit (IC).

Typically, a fiber optic communication link includes a fiber optic transmitting device such as a laser, an optical interconnect link, and a light receiving element such as a photo detector. Currently, 10 Gbits/s optical links using an 850 nm transceiver over multi-mode fiber are implemented in network systems. However, at 10 Gbits/s modal dispersion causes optical signals to be degraded. As a result, the links are limited to approximately 30 meters, providing reach limitations in multi-mode fiber.

### BRIEF DESCRIPTION OF THE DRAWINGS

The present invention will be understood more fully from the detailed description given below and from the accompanying drawings of various embodiments of the invention. The drawings, however, should not be taken to limit the invention to the specific embodiments, but are for explanation and understanding only.

FIG. 1 illustrates one embodiment of a network;

FIG. 2 illustrates one embodiment of a computer system; and

FIG. 3 illustrates one embodiment of a network controller.

### DETAILED DESCRIPTION

According to one embodiment, a mechanism to extend the distance of an optical link is disclosed. Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

In the following description, numerous details are set forth. It will be apparent, however, to one skilled in the art, that the present invention may be practiced without these specific details. In other instances, well-known structures and devices are shown in block diagram form, rather than in detail, in order to avoid obscuring the present invention.

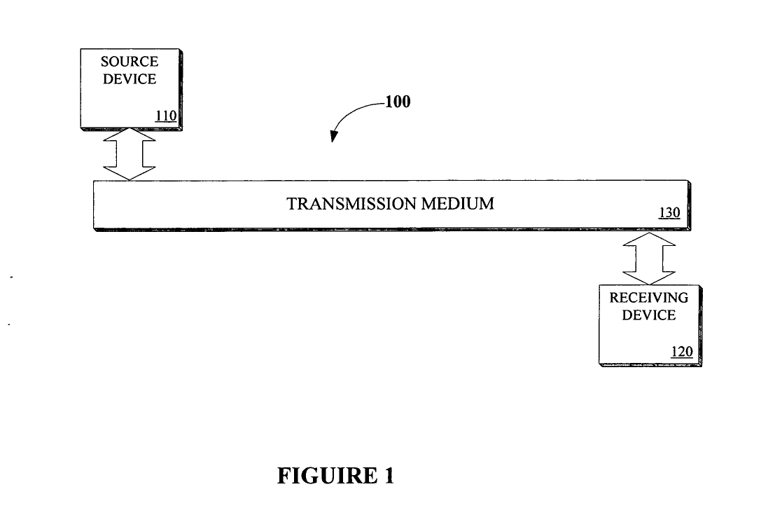

FIG. 1 illustrates one embodiment of a network 100. Network 100 includes a computer system 110 and a computer system 120 coupled via a transmission medium 130. In one embodiment, computer system 110 operates as a source device that transmits data to computer system 120, operating as a receiving device. The data may be, for example, a file, programming data, an executable, voice data, or other digital objects. The data is sent via data transmission medium 130.

According to one embodiment, network 100 is a wide area network, and data transmission medium 130 is implemented via an optical link. In a further embodiment, computer system 110 may be a data server, while computer system 120 is a personal computer system.

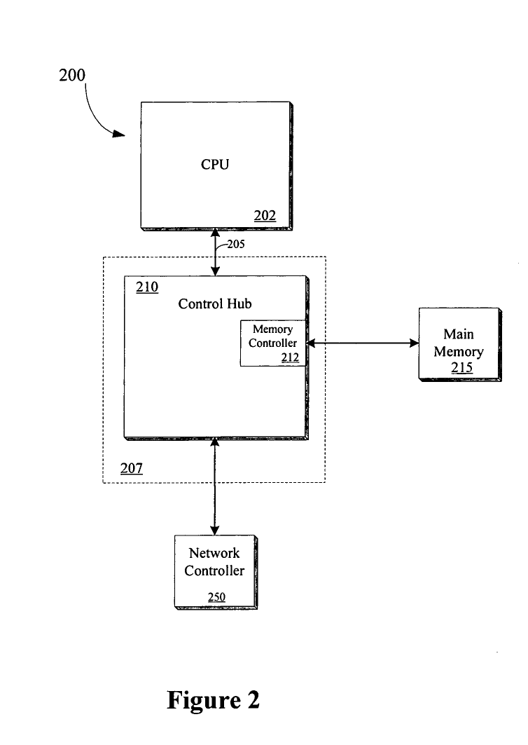

FIG. 2 is a block diagram of one embodiment of a computer system 200. Computer system 200 may be implemented as computer system 110 or computer system 120 (both shown in FIG. 1). Computer system 200 includes a central processing unit (CPU) 202 coupled to an interface 205. In one embodiment, CPU 202 is a processor in the Pentium® family of processors including the Pentium® IV processors available from Intel Corporation of Santa Clara, Calif. Alternatively, other CPUs may be used. In a further embodiment, CPU 202 may include multiple processor cores.

According to one embodiment, interface 205 is a front side bus (FSB) that communicates with a control hub 210 component of a chipset 207. Control hub 210 includes a memory controller 212 that is coupled to a main system memory 215. Main system memory 215 stores data and sequences of instructions and code represented by data signals that may be executed by CPU 102 or any other device included in system 200.

In one embodiment, main system memory 215 includes dynamic random access memory (DRAM); however, main system memory 215 may be implemented using other memory types. According to one embodiment, control hub 210 also provides an interface to input/output (I/O) devices within computer system 200.

For example control hub 210 may be coupled to a network controller 250. Network controller 250 that facilitates a wide area network between computer system 200 and a remote device. Note that in other embodiments, network controller 250 may be included within control hub 210. According to one embodiment, network controller 250 communicates data between computer system 110 and computer system 120 via a Bluetooth interface.

In one embodiment, the wide area network is implemented via a 10 Gbits/s optical link using multi-mode fiber coupled between computer system 110 and 120. As discussed above, modal dispersion causes optical signals operating at 10 Gbits/s to be degraded at certain distances. Thus, the link is limited to approximately 30 meters.

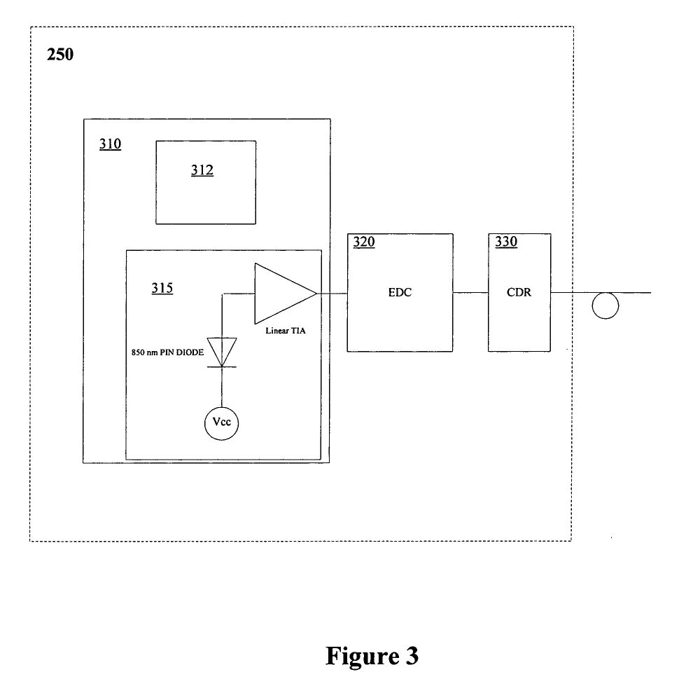

According to one embodiment, network controller 250 includes a mechanism to increase the link distance between computer system 110 and computer system 120. FIG. 3 illustrates one embodiment of network controller 250. Network controller 250 includes an optical transceiver 310, electrical dispersion compensation (EDC) unit 320 and clock and data recovery (CDR) module 330.

Transceiver 310 transmits and receives optical signals over the network. In one embodiment, transceiver is a 850 nm transceiver that includes a vertical cavity surface emitting laser (VCSEL) transmitter 312 to perform electrical to optical conversions. In other embodiments, an array of VCSEL transmitters 312 may be implemented operating in parallel. In addition, transceiver 310 includes a receiver 314. Receiver 314 includes a PIN photodiode and a transimpedance amplifier (TIA).

The PIN photodiode that transform optical signals into an electrical current. In one embodiment, the PIN photodiode is a 850 nm photodiode. The TIA boosts the strength of optical signals received at transceiver 310. According to one embodiment, the TIA is a linear TIA. A linear TIA enables a received signal to retain more information than a non-linear or limiting TIA, with wider dynamic range.

The TIA is coupled to EDC 320. EDC 320 compensates for modal dispersion in signals received at receiver 310 caused by a multimode fiber. In one embodiment, EDC 320 performs adaptive filter techniques on the received signals. CDR 330 recovers clock and data information received from an optical fiber by sampling the received signal to determine an optimum bit period and coping with dispersions. In one embodiment, CDR 330 automatically detects an optimum sampling point.

In a further embodiment, EDC 320 and CDR 330 may be integrated to reduce space on a printed circuit board (PCB) on which network controller 250 is mounted. In addition, although described with reference to a network controller, embodiments of the above-described invention may be incorporated within the transceiver, which may be mounted on chipset 207.

Embodiments of the invention described above may increases the link distance of a multimode 10GBASE-SR transceiver, while remaining compliant with the Institute of Electrical & Electronics Engineers (IEEE) 802.3ae standard. For example, the link distance may be increased from approximately 30 meters to over 120 meters on low quality fibers. Moreover, embodiments of the invention enable the use of lower-cost (and varying bandwidth) receiver elements in a multimode 10GBASE-SR transceiver, which have the ability to reach 30 meters and maintain standards compliance.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as the invention.

What is claimed is:

1. a system comprising:
a multimode optical fiber; and
a network controller coupled to the optical fiber having:
a receiver; and
an electrical dispersion compensation (EDC) unit to compensate for modal dispersion in optical signals received from the optical fiber.

2. The system of claim 1 wherein the network controller further comprises a clock and data recovery (CDR) module coupled to the EDC.

3. The system of claim 1 wherein the receiver comprises:
a transimpedance amplifier (TIA) coupled to the EDC; and
a PIN photodiode coupled to the TIA.

4. The system of claim 3 wherein the TIA is a linear TIA.

5. The system of claim 4 wherein the PIN photodiode operates at 850 nm.

6. The system of claim 1 wherein the EDC performs adaptive filter techniques to compensate for modal dispersion.

7. The system of claim 1 further comprising a first optical transmitter, coupled to the optical fiber to transmit the optical signal.

8. A method comprising:
receiving one or more signals signal at a transceiver from a multimode optical fiber; and
performing electrical dispersion compensation (EDC) on the signals to compensate for modal dispersion.

9. The method of claim 8 further comprising amplifying the signals at a linear transimpedance amplifier (TIA) after performing the EDC.

10. The method of claim 9 further comprising receiving the amplified signals at a PIN photodiode.

11. The method of claim 10 wherein the PIN photodiode operates at 850 nm.

12. The method of claim 8 wherein the process of performing EDC comprises performing adaptive filter techniques.

13. The method of claim 8 further comprising performing clock and data recovery (CDR) to the signals prior to performing the EDC.

14. An optical transceiver comprising:
a receiver; and
an electrical dispersion compensation (EDC) unit, coupled to the receiver, to compensate for modal dispersion in signals received from a multimode optical fiber coupled to the transceiver.

15. The transceiver of claim 14 further comprising a clock and data recovery (CDR) module coupled to the EDC.

16. The transceiver of claim 15 wherein the receiver comprises:
a transimpedance amplifier (TIA) coupled to the EDC; and
a PIN photodiode coupled to the TIA.

17. The transceiver of claim 16 wherein the TIA is a linear TIA.

18. The transceiver of claim 16 wherein the PIN photodiode operates at 850 nm.

19. The transceiver of claim 14 wherein the EDC performs adaptive filter techniques to compensate for modal dispersion.

20. The transceiver of claim 14 further comprising a transmitter.
